(19) United States
(12) Patent Application Publication
(10) Pub. No.: US 2012/0085922 A1
(43) Pub. Date: Apr. 12, 2012

(54) CHAMBER APPARATUS AND METHOD OF CONTROLLING MOVEMENT OF DROPLET IN THE CHAMBER APPARATUS

(76) Inventors: Takayuki YABU, Hiratsuka-shi (JP); Youichi Sasaki, Hiratsuka-shi (JP); Kouji Kakizaki, Hiratsuka-shi (JP); Osamu Wakabayashi, Hiratsuka-shi (JP)

(21) Appl. No.: 13/253,460

(22) Filed: Oct. 5, 2011

(30) Foreign Application Priority Data
Oct. 6, 2010 (JP) 2010-226943
Mar. 25, 2011 (JP) 2011-067005

(51) Int. Cl. G21K 5/08

(52) U.S. Cl. 250/432 R

(57) ABSTRACT

A chamber apparatus is used in combination with a laser apparatus. The chamber apparatus includes a chamber with an inlet. The inlet is configured for introducing a laser beam into the chamber. A target supply unit is provided to the chamber to supply a target material into the chamber. The target supply unit may electrically be isolated from the chamber. A potential control unit is connected to at least the target supply unit, and configured to control the supply of the target material.

### CROSS-REFERENCE TO RELATED APPLICATIONS

This application claims priority of Japanese Patent Application No. 2010-226943, filed Oct. 6, 2010, and Japanese Patent Application No. 2011-067005, filed Mar. 25, 2011, the entire contents of each of which are hereby incorporated by reference.

### BACKGROUND

1. Technical Field

This disclosure relates to a chamber apparatus and a method of controlling movement of a droplet in the chamber apparatus.

2. Related Art

Photolithography processes have been continuously improving for semiconductor device fabrication. Extreme ultraviolet (EUV) light at a wavelength of approximately 13 nm is useful in the photolithography processes to form extremely small features (e.g., 32 nm or less features) in, for example, semiconductor wafers.

Three type of systems for generating EUV light have been well known. The systems includes an LPP (Laser Produced Plasma) type system in which plasma generated by irradiating a target material with a laser beam is used, a DPP (Discharge Produced Plasma) type system in which plasma generated by electric discharge is used, and an SR (Synchrotron Radiation) type system in which orbital radiation is used.

### SUMMARY

Embodiments detailed herein describe a chamber apparatus used in combination with a laser apparatus. The chamber apparatus may include a chamber with an inlet. The inlet may be configured for introducing a laser beam into the chamber. A target supply unit may be provided to the chamber, and configured to supply a target material into the chamber. A potential control unit can be connected to at least the target supply unit, and configured to control the supply of the target material. The target supply unit may electrically be isolated from the chamber.

Additional aspects and advantages of the present disclosure will become readily apparent to those skilled in the art from the following detailed description, wherein only exemplary embodiments of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1 schematically illustrates the configuration of a chamber apparatus according to a first embodiment.

FIG. 2A shows a potential change along a movement path (trajectory) of a droplet; and FIG. 2B shows a change in the applied potential along the movement path (trajectory) of the droplet.

FIG. 3 schematically illustrates the configuration of a chamber apparatus according to a second embodiment.

FIG. 4A shows a potential change along a movement path of a droplet in a chamber apparatus according to a third embodiment; and FIG. 4B shows a change in the applied potential along the movement path of the droplet in the chamber apparatus according to the third embodiment.

FIG. 5 schematically illustrates the configuration of a chamber apparatus according to a fourth embodiment.

FIG. 6 shows a potential change along a movement path of a droplet.

FIG. 7 schematically illustrates the configuration of a chamber apparatus according to a fifth embodiment.

FIG. 8A shows a potential change along a movement path of a droplet; and FIG. 8B shows a change in the applied potential along the movement path of the droplet.

FIG. 9A shows a potential change along a movement path of a droplet in a chamber apparatus according to a sixth embodiment; and FIG. 9B shows a change in the applied potential along the movement path of the droplet in the chamber apparatus according to the sixth embodiment.

FIG. 10A shows a potential change along a movement path of a droplet in a chamber apparatus according to a seventh embodiment; and FIG. 10B shows a change in the applied potential along the movement path of the droplet in the chamber apparatus according to the seventh embodiment.

FIG. 11 shows a potential change along a movement path of a droplet in a chamber apparatus according to an eighth embodiment.

FIG. 12 schematically illustrates the arrangement of electrodes and so forth in a chamber apparatus according to a ninth embodiment.

FIG. 13 schematically illustrates the arrangement of electrodes and so forth in a chamber apparatus according to a tenth embodiment.

FIG. 14 schematically illustrates the arrangement of electrodes and so forth in a chamber apparatus according to an eleventh embodiment.

FIG. 15A illustrates an example of a tubular conductor in a chamber apparatus according to a twelfth embodiment; FIG. 15B illustrates a modification of a tubular conductor in the chamber apparatus according to the twelfth embodiment; and FIG. 15C illustrates another modification of a tubular conductor in the chamber apparatus according to the twelfth embodiment.

FIG. 16 shows a potential changer along a movement path of a droplet according to a thirteenth embodiment.

FIG. 17 schematically illustrates the arrangement of electrodes and so forth in a chamber apparatus according to a fourteenth embodiment.

FIG. 18 schematically illustrates the arrangement of electrodes and so forth in a chamber apparatus according to a fifteenth embodiment.

FIG. 19 schematically illustrates the arrangement of electrodes and so forth in a chamber apparatus according to a sixteenth embodiment.

FIG. 20 schematically illustrates the arrangement of electrodes and so forth in a chamber apparatus according to a seventeenth embodiment.

FIG. 21 schematically illustrates the arrangement of electrodes and so forth in a chamber apparatus according to an eighteenth embodiment.

FIG. 22 schematically illustrates the configuration for supporting electrodes and so forth in a chamber apparatus according to a nineteenth embodiment.

FIG. 23 schematically illustrates the configuration for supporting electrodes and so forth in a chamber apparatus according to a twentieth embodiment.

FIG. 24 schematically illustrates the configuration of a chamber apparatus according to a twenty-first embodiment.

FIG. 25 schematically illustrates the arrangement of electrodes and so forth in a chamber apparatus according to a twenty-second embodiment.

### DESCRIPTION OF PREFERRED EMBODIMENTS

Embodiments of this disclosure will be described in detail with reference to the accompanying drawings. In the subsequent description, each drawing merely illustrates shape, size, positional relationship, and so on, schematically to the extent that enables the content of this disclosure to be understood; thus, this disclosure is not limited to the shape, the size, the positional relationship, and so on, illustrated in each drawing. In order to show the configuration clearly, part of hatching along a section is omitted in the drawings. Further, numerical values indicated hereafter are merely preferred examples of this disclosure; thus, this disclosure is not limited to the indicated numerical values.

### First Embodiment

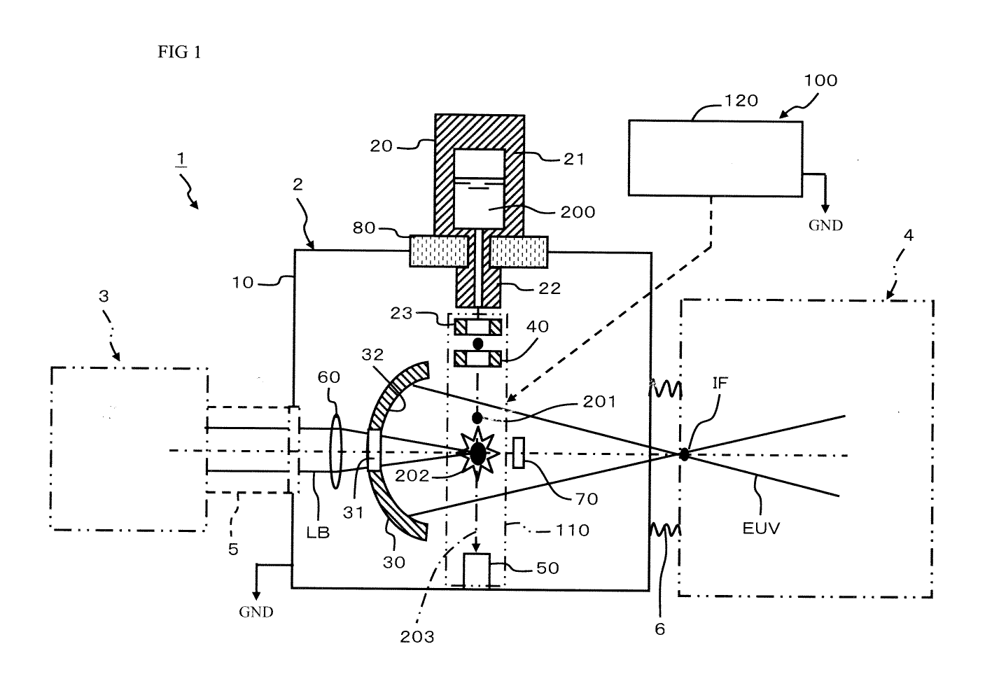

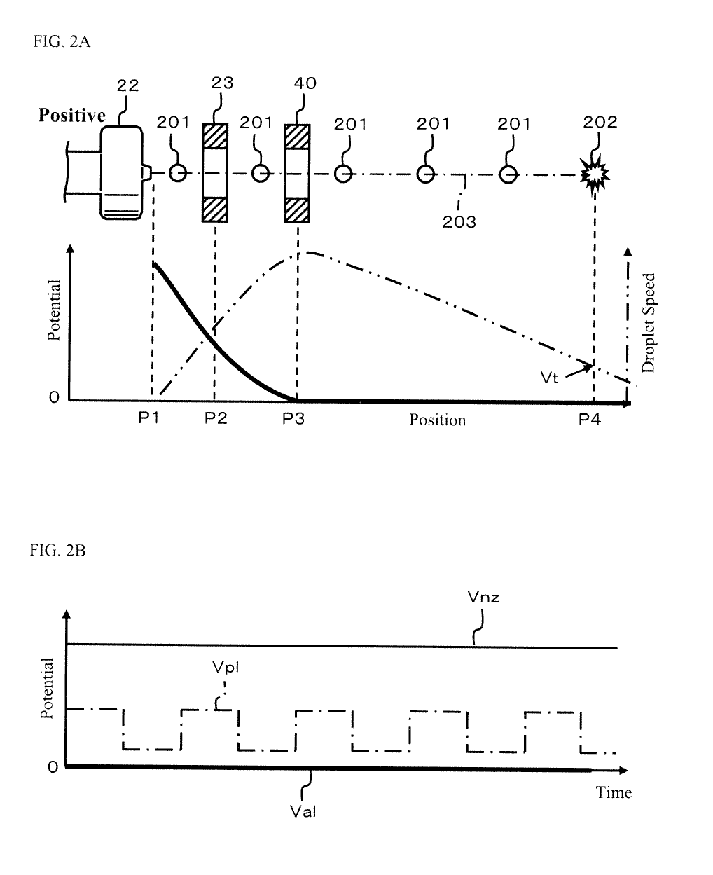

A first embodiment of this disclosure will be described with reference to FIGS. 1 through 2B. FIG. 1 illustrates the general configuration of an EUV exposure system 1, in which a chamber apparatus 2 of the first embodiment is employed. The EUV exposure system 1 may include, for example, the chamber apparatus 2, a driver laser apparatus 3, and an EUV exposure apparatus 4.

The chamber apparatus 2 may, for example, include a chamber 10, a droplet generator 20, a collector mirror 30, a collection unit 50, and a beam dump 70. Further, the chamber apparatus 2 maybe connected to a potential control mechanism 100. The chamber apparatus 2, together with the driver laser apparatus 3, may be an EUV light generation system.

The general operation of the EUV light generation system will be described first, and subsequently, a method of controlling the movement of a droplet in the chamber apparatus will be described.

Inside the chamber 10 may preferably be maintained in a highly vacuum state. The chamber 10 may be grounded, and thus be at the ground potential. The EUV light generated inside the chamber 10 may be focused at an intermediate focus (IF) defined around the border between a connector 6 and the EUV exposure apparatus 4, and subsequently be outputted to the EUV exposure apparatus 4.

The droplet generator 20 may, for example, include a main body 21, a nozzle unit 22, a first electrode 23, and a second electrode 40. The nozzle unit 22 may be provided at a leading end of the main body 21. The first electrode 23 may be provided through an insulator (not shown) to a leading end side of the nozzle unit 22. The second electrode 40 may also be provided through an insulator (not shown) to the first electrode 23. The nozzle unit 22, the first electrode 23, and the second electrode 40 are spaced apart from each other by gaps, respectively.

A material (target material) 200 to be supplied as a droplet may be stored inside the main body 21. Tin (Sn), but not limited to, may serve as the target material 200, for example. The target material 200 inside the main body 21 may be heated by a heater Thus, the target material may be maintained in a molten state. However, the target material 200 inside the main body 21 does not need to be maintained in a molten state in its entirety at all times, and it is sufficient for the target material 200 to be in a molten state at least when the target material 200 is outputted from the nozzle unit 22.

The first electrode 23 may be disposed to be adjacent to the nozzle unit 22 having an outlet formed at the leading end thereof. When a potential is applied to the first electrode 23, the target material 200 in a molten state may slightly protrude from the nozzle unit 22 due to electrostatic force. An electric field may be enhanced at the target material 200 protruding from the nozzle unit 22. As a result, the target material 200 may be outputted from the nozzle unit 22 due to the electrostatic force. The above-mentioned state in which the target material 200 slightly protrudes from the nozzle unit 22 may also be created by applying physical pressure to the target material 200. For example, piezoelectric element may be provided on a side wall of the nozzle unit 22 so as to deform the piezoelectric element at predetermined timing. As a result, the target material 200 may slightly protrude from the nozzle unit 22. A potential is applied to the first electrode 23 when the target material 200 slightly protrudes from the nozzle unit 22. Then, the target material may be outputted from the nozzle unit 22.

The target material 200 outputted from the nozzle unit 22 by the electrostatic force may form a droplet 201. The droplet 201 pulled out by the electrostatic force may be charged. Thus, the droplet 201 can be accelerated when a potential is applied to the second electrode 40 and travel toward the plasma generation region (P4 in FIG. 2A). In the first embodiment, a potential gradient exists from the nozzle unit 22 toward the plasma generation region. Accordingly, the charged droplet 201 may be subjected to the influence of the potential gradient so that the droplet travels toward the plasma generation region.

When the droplet 201 reaches the plasma generation region, the droplet 201 may be irradiated with a driver laser beam LB from the driver laser apparatus 3. For example, a CO₂ pulsed laser apparatus can be used as the driver laser apparatus 3.

The driver laser beam LB from the driver laser apparatus 3 may travel through a laser beam channel 5 which connects the driver laser apparatus 3 to the chamber 10, and subsequently may enter the chamber 10. The driver laser beam LB may strike the droplet 201 via a focusing optical system 60 and a through-hole 31 of the collector mirror 30.

When the droplet 201 is irradiated with the driver laser beam LB, the droplet 201 may be turned into plasma 202 and the EUV light may be emitted from the plasma 202. The EUV light may be reflected at a reflective surface 32 of the collector mirror 30 and subsequently be focused at the intermediate focus IF.

The beam dump 70 may be provided on a beam path of the driver laser beam LB passing through the through-hole 31. The dump may absorb the energy of the driver laser beam LB and transform it into heat energy. The beam dump 70 may be provided with a cooling mechanism. Aside from the beam dump 70, any element which needs to be cooled may be provided with a cooling mechanism if appropriate.

When the droplet 201 is irradiated with the driver laser beam LB, debris may be generated. The debris may be collected by the collection unit 50 disposed inside the chamber 10. The collection unit 50 faces the leading end of the droplet generator 20 for collecting the debris.

The potential control mechanism 100 maybe configured to cause a potential control device 120 to control potential of components in a potential control region 110 (e.g., the first electrode 23, the second electrode 40, and the collection unit 50, but not limited to them). A potential gradient suitable for controlling the droplet 201 to reach the plasma generation region at a predetermined speed (Vt in FIG. 2) may be generated inside the chamber 10. As will be described later in relation to other embodiments, potential control can be performed on at least any one of the first electrode 23, the second electrode 40, the collector mirror 30, the collection unit 50, the chamber 10, and the nozzle unit 22.

FIGS. 2A and 213 show a potential distribution along a traveling path 203 of the droplet 201. FIG. 2A shows a relationship between a potential variation and an arrangement of the nozzle unit 22, the first electrode 23, and the second electrode 40. FIG. 2B shows a relationship among a potential Vnz applied to the nozzle unit 22, a potential Vpl applied to the first electrode 23, and a potential Val applied to the second electrode 40.

In the first embodiment, a positive constant potential may be applied to the nozzle unit 22. The potential Vpl, which is lower than the positive potential Vnz of the nozzle unit 22 may be applied in the form of pulse trains to the first electrode 23 in order to pull out the droplet 201 from the nozzle unit 22 (Vnz>Vpl). The generation cycle of the droplet 201 maybe determined in accordance with the pulse cycle. FIG. 2B shows that the potential Vpl applied to the first electrode 23 is, but not limited to, a rectangular wave pulse.

The potential Val, which is lower than the potential Vpl of the first electrode 23, may be applied to the second electrode 40 in order to accelerate the droplet 201 pulled out when the potential Vpl is applied to the first electrode 23 (Vpl>Val). The potential Val of the second electrode 40 maybe set at the ground potential, for example.

In FIG. 2A, the speed of the droplet 201 along the traveling path 203 is shown in dashed-two dotted line. In this disclosure, the speed and potential distribution shown in the figures are merely schematic to the extent that facilitates the understanding of the embodiments.

The speed of the droplet 201 is 0 at a position P1 where the leading end of the nozzle unit 22 is located. The droplet 201 may be pulled out from the nozzle unit 22 when the potential is applied to the first electrode 23, and may subsequently be accelerated. The potential may drop at a position P2 where the first electrode 23 is located along the traveling path 203 of the droplet 201, whereas the speed of the droplet 201 maybe increased. The droplet 201 may further be accelerated when the potential is applied to the second electrode 40. The droplet 201 may be at the highest speed at a position P3 where the second electrode 40 is located. Thereafter, the droplet 201 may travel toward the plasma generation region P4 along the traveling path 203 while being gradually decelerated. The speed of the droplet 201 in the plasma generation region P4 may preferably be at or above the predetermined speed Vt.

In other words, the potential Vnz of the nozzle unit 22, the potential Vpl of the first electrode 23, and the potential Val of the second electrode 40 may be set such that the speed of the droplet 201 reaches the speed Vt or above in the plasma generation region P4.

In the first embodiment, since the chamber 10 may be grounded, the accelerated droplet 201 may be less likely to be influenced by the potential of the chamber 10 and the potential of structural elements of the chamber 10. That is, it is less likely that the droplet 201 may be decelerated due to the potential of the chamber 10 and the potential of the structural elements. Accordingly, the small-sized droplet 201 can reach the plasma generation region stably at the predetermined speed Vt or above.

In the first embodiment, the speed of the small-sized droplet 201 maybe stably controlled at or above the predetermined speed Vt. This may prevent the trajectory of a succeeding droplet from being disturbed by a scattered material generated when the droplet 201 is irradiated with the laser beam for plasma formation. As a result, it may become possible to have each droplet be irradiated with the laser beam under substantially the same condition. That is, with the first embodiment, the EUV light may be generated stably. Furthermore, the EUV light may be generated stably even with a relatively small-sized droplet having the smallest volume required to generate desirable EUV light. The volume of the droplet may not need to be increased more than necessary in order to prevent the case where the trajectory of the droplet varies and the droplet is not irradiated with the laser beam stably. In the first embodiment, since the droplet having the required minimum volume can be turned into plasma stably, debris to be generated may be reduced. When debris is generated, the debris may be collected into the collection unit 50.

Further, the nozzle unit 22 may be set at a positive potential; thus, compared to the case where the nozzle unit 22 is set at a negative potential, field electron emission from the leading end of the nozzle unit 22 when the potential Vpl is applied to the first electrode 23 may be suppressed. Accordingly, even when a gas exists in the chamber 10 at a low pressure, the possibility of breakdown occurring between the first electrode 23 and the nozzle unit 22 may be suppressed.

### Second Embodiment

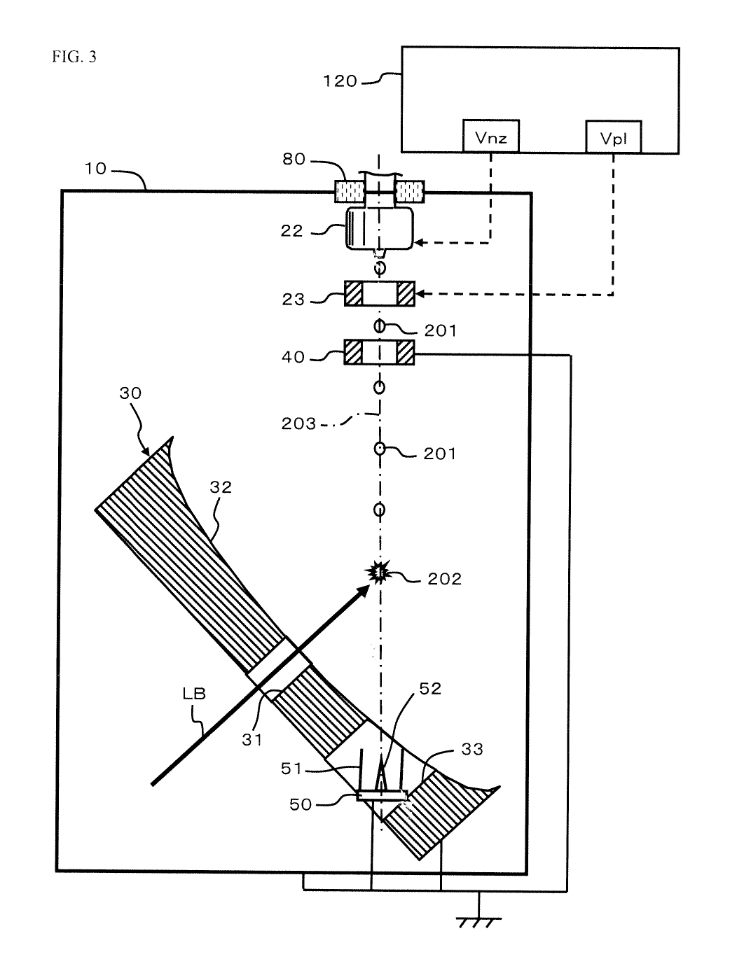

Embodiments described hereinafter may be modifications of the first embodiment. Thus, differences between the first embodiment and the following embodiments will be described first. A second embodiment will be described with reference to FIG. 3 which is an enlarged view of the chamber apparatus 2.

In the second embodiment, an opening 33 in which the collection unit 50 may be disposed can be formed in a predetermined region of the collector mirror 30. The predetermined region may be a region (obscuration region) corresponding to an optical path of the EUV light that may not be used for exposure in the EUV exposure apparatus 4.

The collection unit 50 may, for example, include a cylindrical collection body 51 and a third electrode 52 disposed at substantially the center of the collection body 51. In the second embodiment, the second electrode 40, the collector mirror 30, the chamber 10, and the collection unit 50 may be grounded. Accordingly, the potential Val of the second electrode 40, the potential of the collector mirror 30, the potential of the chamber 10, and the potential of the collection unit 50 may be set at the ground potential.

In the second embodiment, aside from the chamber 10, the collector mirror 30 and so forth are grounded. Thus, the influence of the potential on the traveling path 203 of the droplet 201 may be reduced. This may allow the droplet 201 to travel stably along the traveling path.

Further, since the collection unit 50, which is grounded, may be disposed in the obscuration region, the debris may be collected without affecting the use of the EUV light.

### Third Embodiment

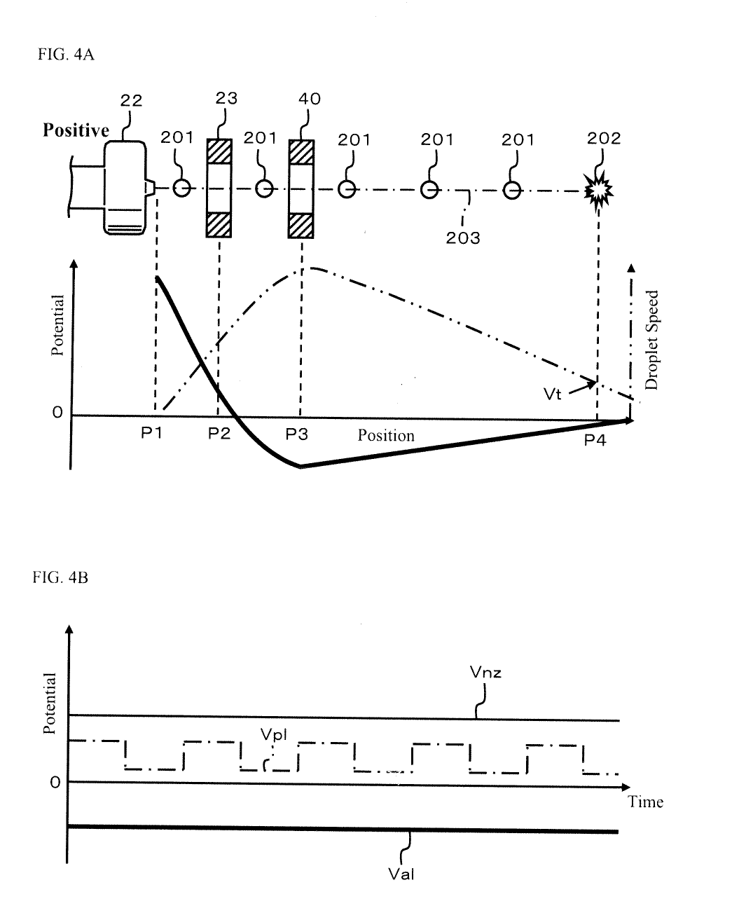

A third embodiment will be described with reference to FIGS. 4A and 4B. In the third embodiment, the potential Val of the second electrode 40 may be set at a negative potential.

A potential difference between the potential Vnz of the nozzle unit 22 and the potential Val of the second electrode 40 may be set similarly to those shown in FIG. 2, or may be set differently from those shown in FIG. 2. That is, the potential gradient from the nozzle unit 22 to the second electrode 40 may be set similarly to the potential gradient in the first embodiment, or maybe set to be greater or smaller than the potential gradient in the first embodiment.

### Fourth Embodiment

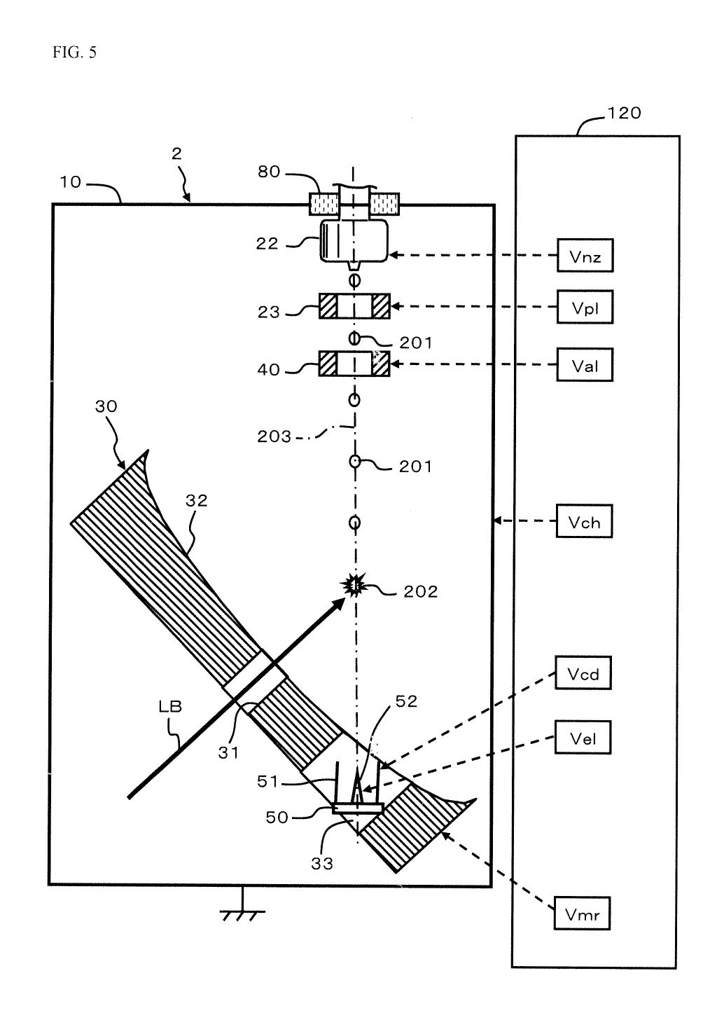

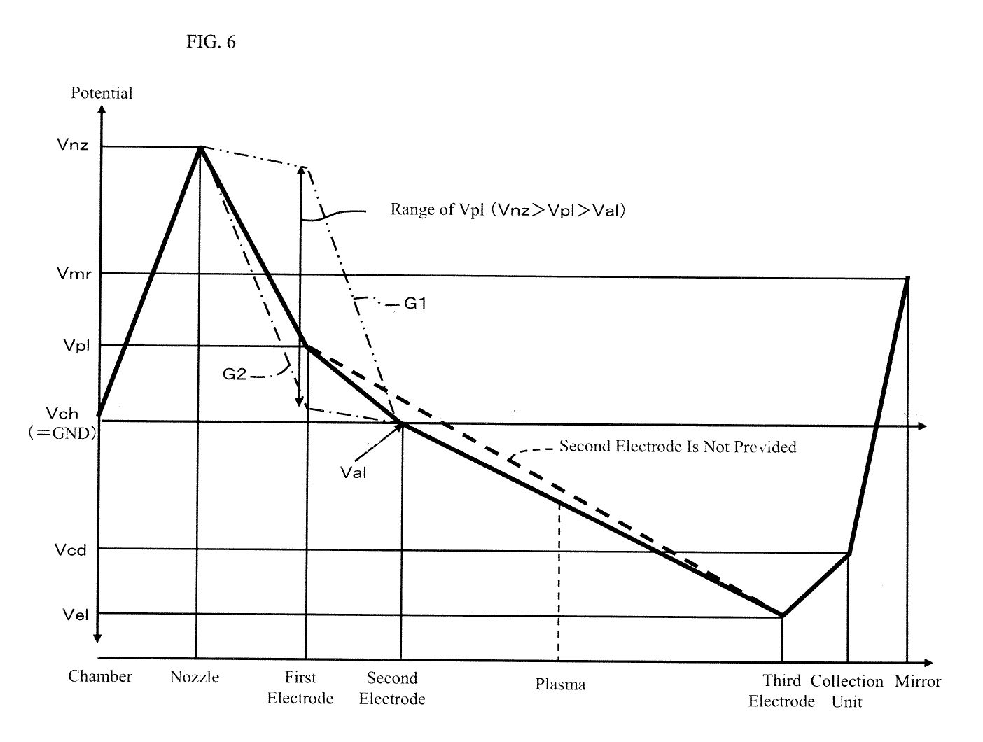

A fourth embodiment will be described with reference FIGS. 5 and 6. The potential control device 120 of the fourth embodiment may be configured to control the potential Vnz of the nozzle unit 22, the potential Vpl of the first electrode 23, the potential Val of the second electrode 40, potential Vch of the chamber 10, potential Vcd of the collection body 51, potential Vel of the third electrode 52, and potential Vmr of the collector mirror 30. In the configuration shown in FIG. 5, the potential Vnz, the potential Vpl, the potential Val, the potential Vch, the potential Vcd, the potential Vel, and the potential Vmr may be included in the potential control region 110.

FIG. 6 illustrates an example of the potential control. A thick solid line in FIG. 6 indicates an example of a potential change. The potential Vch of the chamber 10 may be set at the ground potential. The potential Vnz of the nozzle unit 22 may be set at the highest positive potential. The highest positive potential here refers to the highest value relative to potential of the other elements shown in FIG. 6.

The potential Vpl of the first electrode 23 may be set at a positive potential lower than he potential Vnz of the nozzle unit 22. The potential Val of the second electrode 40 may be set at the ground potential. The potential Vel of the third electrode 52 may be set at the lowest negative potential. The lower negative potential here refers to the smallest value relative to the potentials of the other constituent elements shown in FIG. 6. The potential Vcd of the collection body 51 may be set to a potential higher than the potential Vel of the third electrode 52. The potential Vmr of the collector mirror 30 may be set at a potential higher than the potential Vpl of the first electrode 23 and lower than the potential Vnz of the nozzle unit 22.

The droplet 201 accelerated by applying potential to the first electrode 23 and the second electrode 40, respectively, may travel toward the plasma generation region. It should be noted that FIG. 6 merely shows the position of the plasma generation region in order to facilitate the understanding of this disclosure and does not indicate the potential of the plasma 202.

Droplets 201 that have not been irradiated with the driver laser beam LB, and debris may travel toward the third electrode and be collected into the collection body 51. The collection body 51 may be set at the potential Vcd, which is slightly higher than the potential of the third electrode 52 provided at substantially the center of the collection body 51. Droplets 201 that have not been irradiated with the driver laser beam LB, and debris may thus be collected at substantially the center of the collection body 51.

The positive potential Vmr may be applied to the collector mirror 30. Charged debris, droplets 201 that have not been irradiated with the driver laser beam LB may have the potential of the same polarity as that of the collector mirror 30. This may make it possible to prevent the debris from adhering to the collector mirror 30 due to electrical repulsion.

A dashed line in FIG. 6 indicates a potential change when the second electrode 40 is removed from the configuration shown in FIG. 5. When a potential is applied to the third electrode 53 (and the collection body 51) in order to pull the droplet 201 to the third electrode 53, the second electrode 40 may not need to be provided. This is so because the third electrode 53 (and the collection body 51) may perform the function of the second electrode 40.

As shown in FIG. 6, the potential Vpl of the first electrode 23 may be set to a desired value between the potential Vnz and the potential Val (Vnz>Vpl>Val). The potential Vpl of the first electrode 23 may preferably be varied between the potential Vnz and the potential Val when the potential Vpl is applied in the form of pluses trains.

### Fifth Embodiment

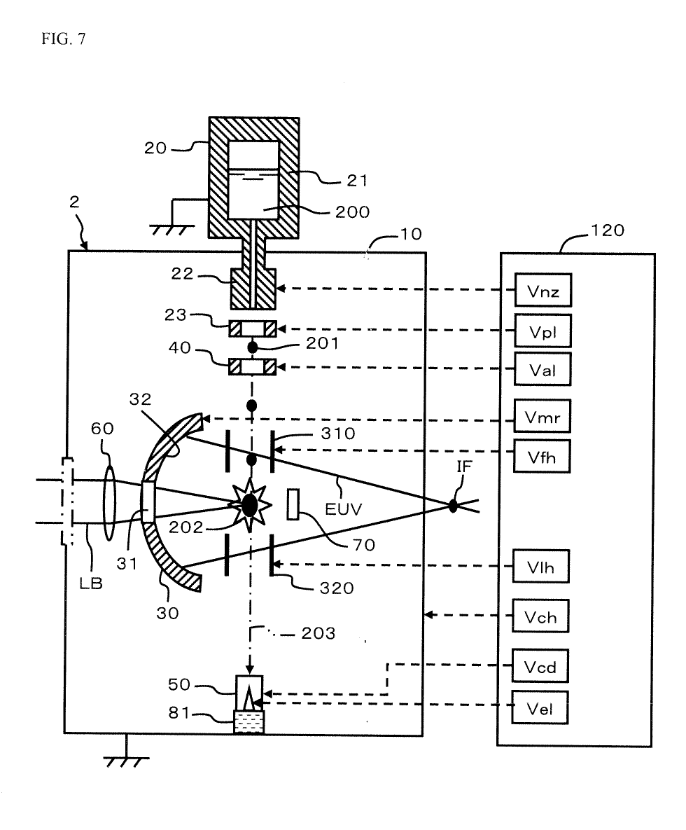

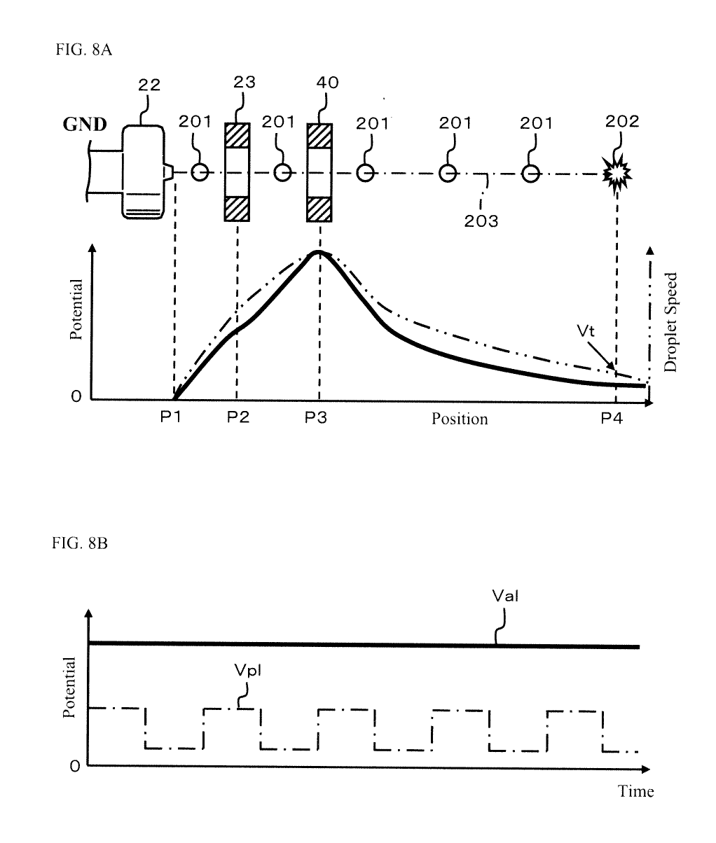

A fifth embodiment will be described with reference to FIGS. 7 through 8B. In some of the embodiments to be described hereinafter, including the fifth embodiment, the potential Vnz of the nozzle unit 22 may be set at the ground potential. FIG. 7 illustrates an example of the configuration of the chamber apparatus 2 according to the fifth embodiment.

In the chamber apparatus 2 according to the fifth embodiment, the droplet generator 20 maybe grounded. Accordingly, the insulator 80 may not need to be provided between the droplet generator 20 and the chamber 10. A positive potential may be applied to the collection unit 50. Accordingly, the insulator 81 maybe provided between the collection unit 50 and the chamber 10.

In the configuration shown in FIG. 7, tubular conductors 310 and 320 may be provided in order to prevent the potential distribution along the traveling path 203 of the droplet 201 from being influenced by potential of the structural elements in the chamber 10. The tubular conductors 310 and 320 will be described in detail later in relation to another embodiment. Potential Vfh and potential Vlh of the tubular conductors 310 and 320, respectively, may also be controlled by the potential control device 120, as well as the potential Vnz, the potential Vpl, the potential Val, the potential Vch, the potential Vcd, and the potential Vel.

FIGS. 8A and 8B show the potential setting and so forth in the case where the potential Vnz of the nozzle unit 22 is set at the ground potential. Note that potential of the tubular conductors 310 and 320 and the collection unit 50 are not shown in FIGS. 8A and 8B. FIG. 8A shows the potential and the speed of the droplet 201 along the traveling path 203; and FIG. 8B shows an example of the potential Vpl applied in the form of pulse trains to the first electrode 23 and an example of the constant potential Val applied to the second electrode 40.

The potential Vnz of the nozzle unit 22 may be set at the ground potential. Thus, the potential Vpl of the first electrode 23 may preferably be set at a positive potential. The potential Val of the second electrode 40 may preferably be set at a positive potential that is higher than the potential Vpl of the first electrode 23.

In such a configuration, the negatively charged droplet 201 may reach the plasma generation region P4 at or above the predetermined speed Vt as the predetermined potential is applied to the second electrode 40. In other words, the potential Val of the second electrode 40 may preferably be set such that the speed of the droplet 201 at the time of reaching the plasma generation region P4 is at or above the predetermined speed Vt.

The potential Val of the second electrode 40 is required for the droplet 201 to reach the speed Vt or above. The potential Val of the second electrode 40 can be lowered when the position P3 of the second electrode 40 is brought closer to the plasma generation region P4.

### Sixth Embodiment

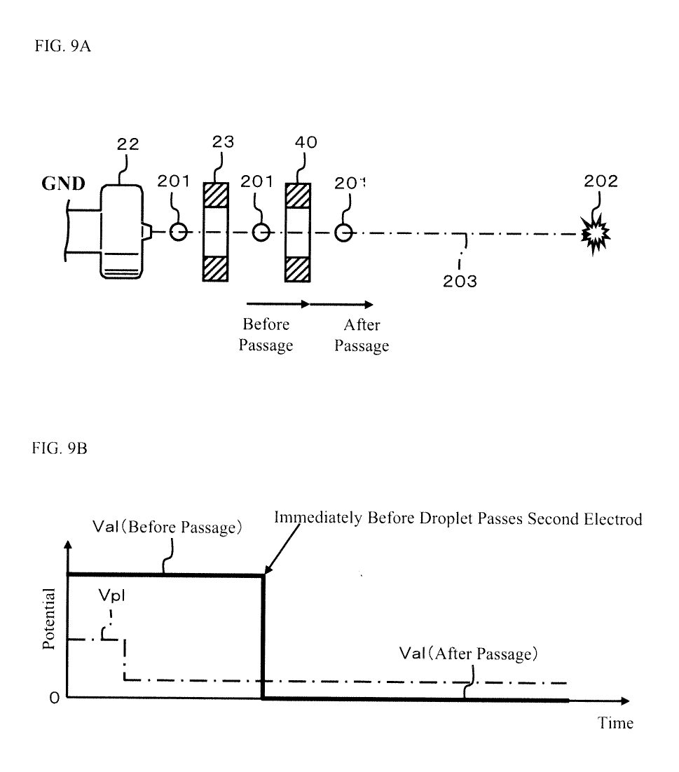

A sixth embodiment will be described with reference to FIGS. 9A and 9B. In the sixth embodiment, the potential applied to the second electrode 40 may be varied over time. FIG. 9A shows an arrangement of the nozzle unit 22, the first electrode 23, and the second electrode 40. FIG. 9B shows changes over time of the potential Vpl of the first electrode 23 and the potential Val of the second electrode 40.

The potential of the second electrode 40 may be set at a positive potential until the droplet 201 pulled out from the nozzle unit 22 passes the second electrode 40. Since the nozzle unit 22 may be set at the ground potential, the electrostatic force may act between the droplet 201 and the second electrode 40. The droplet 201 may thus be attracted toward the second electrode 40 and be accelerated.

The potential Val of the second electrode 40 may be changed to the ground potential immediately before the droplet 201 passes the second electrode 40. Either when the droplet 201 passes the second electrode 40 or immediately after the droplet 201 passes the second electrode 40, the potential Val of the second electrode 40 may be changed to the ground potential. Alternatively, the potential Val of the second electrode 40 may be set at a negative potential.

After the droplet 201 passes the second electrode 40, application of the voltage Val to the second electrode 40 may be stopped. Thus, the droplet 201 having passed the second electrode 40 may be attracted toward the second electrode 40 and thus prevented from being decelerated.

Furthermore, setting the potential Val of the second electrode 40 at a negative potential may allow the electrical repulsion to act between the second electrode 40 and the droplet 201 after the droplet 201 has passed the second electrode 40. Therefore, the droplet 201 may be further accelerated.

### Seventh Embodiment

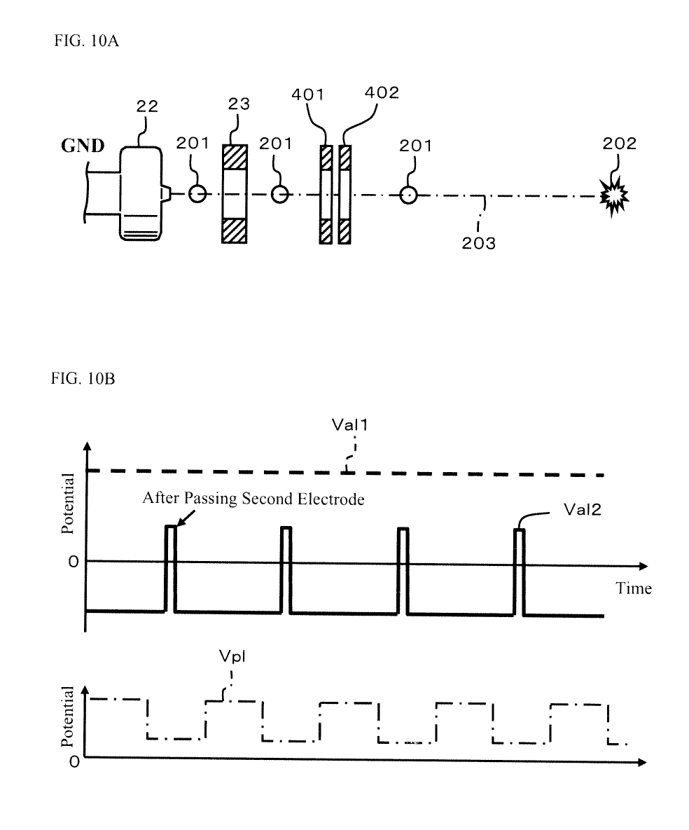

A seventh embodiment will be described with reference to FIGS. 10A and 10B. In the seventh embodiment, two electrodes 401 and 402 are used as the second electrode. FIG. 10A shows an arrangement of electrodes; and FIG. 10B shows an over time change of potential to be applied to the electrodes.

As illustrated in FIG. 10A, the upstream-side electrode 401 and the downstream-side electrode 402 may be disposed downstream of the first electrode 23. Here, upstream and downstream are defined with respect to the traveling direction of the droplet 201.

FIG. 10B shows potential Val1 of the upstream-side electrode 401 and potential Val2 of he downstream-side electrode 402. The constant potential Val1 may be applied to the upstream-side electrode 401. The potential Val2 may be applied in the form of pulse trains to the downstream-side electrode 402.

The potential Val2 will be discussed in detail. The potential Val2 may be changed to a positive potential for a short period of time immediately before the droplet 201 having passed the first electrode 23 reaches the electrode 402. The electrode 401 and the electrode 402 may, in cooperation, electrically attract the droplet 201 and cause the droplet 201 to be accelerated.

The potential Val2 of the electrode 402 may be changed to a negative potential immediately after the droplet 201 passes the electrode 402. This may allow the electrical repulsion to act between the droplet 201 and the electrode 402, which can further accelerate the droplet 201.

### Eighth Embodiment

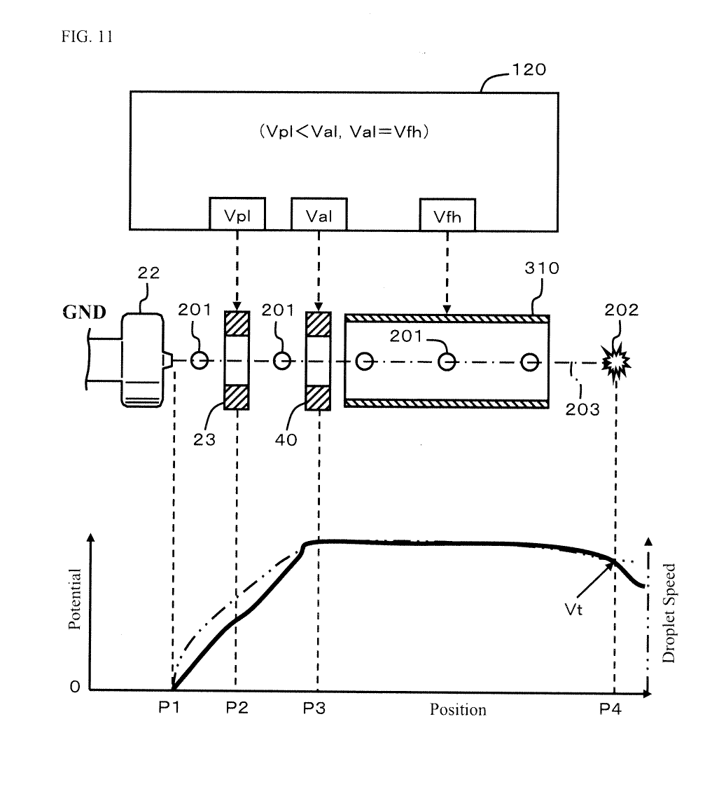

An eighth embodiment will be described with reference to FIG. 11. In the eighth embodiment, a tubular conductor 310 may be provided to prevent the accelerted droplet 201 from being decelerated. The tubular conductor 310 may be configured and positioned not to disturb the beam path of the driver laser beam LB.

The tubular conductor 310 which may be made of an electrically conductive material can be provided between the second electrode 40 and the plasma generation region P4 along the traveling path 203 of the droplet 201. The configuration and the arrangement of the tubular conductor 310 will be described later in detail.

The potential distribution along the traveling path 203 of the droplet 201 is shown in the bottom of FIG. 11. The nozzle unit 22 may be grounded. The potential Vpl of the first electrode may be set at positive potential. The potential Val of the second electrode 40 may be set at positive potential that is higher than the potential Vpl of the first electrode 23. The potential Vfh of the tubular conductor 310 may be set at potential that is substantially equal to the potential Val of the second electrode 40 (Vpl<Val, Val≈Vfh).

The potential inside the tubular conductor 310 may remain constant throughout its entire length. Accordingly, the speed of the droplet 201 traveling inside the tubular conductor 310 is relatively less likely to drop. This may make it possible to achieve the higher speed Vt of the droplet 201 in the plasma generation region P4. In other words, this configuration may allow the speed of the droplet 201 to be at the predetermined speed Vt in the plasma generation region even when the potential Val of the second electrode 40 is set lower.

The tubular conductor 310 may preferably be made of a material resistant to sputtering. Such a material may include, but not limited to, molybdenum, tungsten, tantalum, and carbon. Alternatively, the outer surface of the tubular conductor 310 may be coated with a material resistant to sputtering. Such a coating material may include, but not limited to, molybdenum, tungsten, tantalum silicon, carbon, aluminum oxide, zirconium, and aluminum nitride.

### Ninth Embodiment

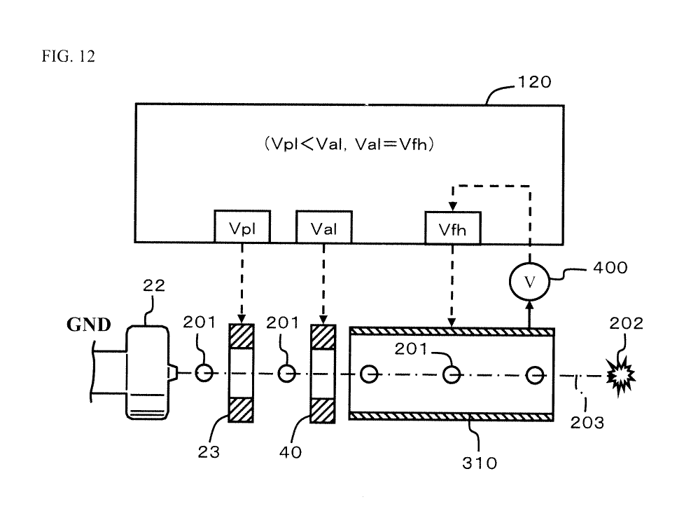

A ninth embodiment will be described with reference to FIG. 12. In the ninth embodiment, feedback control may be carried out in order to maintain the potential of the tubular conductor to be constant.

In the ninth embodiment, an electrometer may be connected to the potential control device 120. An electrometer 400 may be configured to measure the potential of the tubular conductor 310 and may output a detection signal to the potential control device 120. The potential control device 120 may be configured to control the potential to be applied to the tubular conductor 310 based on the inputted detection signal such that the potential of the tubular conductor 310 coincides with the target potential Vfh.

Thus, the potential inside the tubular conductor may be kept constant even when the charged droplet 201 passes through the tubular conductor 310. Accordingly, deceleration of the droplet 201 may more reliably be prevented.

### Tenth Embodiment

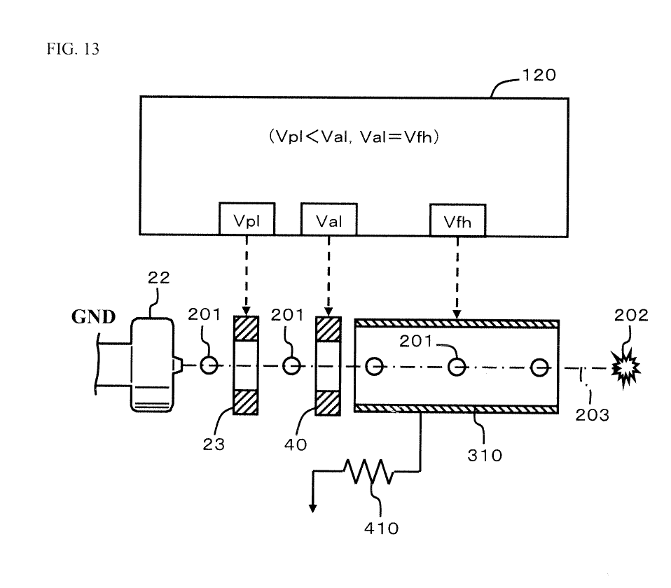

A tenth embodiment will be described with reference to FIG. 13. In the tenth embodiment, the tubular conductor 310 may be connected to the ground or to a power supply via a high-resistance 410. When a charged particle (droplet 201) passes through the tubular conductor 310, the potential of the tubular conductor 310 may change. Thus, the tubular conductor 310 may be connected to the around or the like via the high-resistance 410. Therefore, a potential variation of the tubular conductor 310 may be prevented. Alternatively, a high-resistance coating may be formed on the surface of the tubular conductor 310 to form the high-resistance 410.

### Eleventh Embodiment

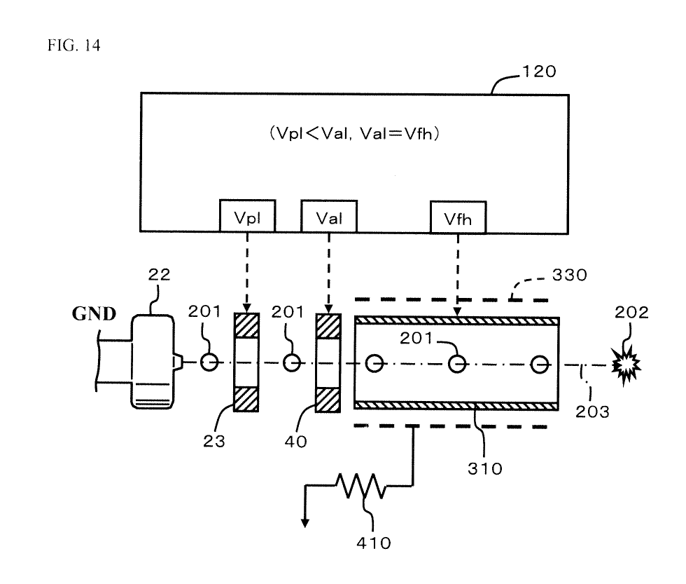

An eleventh embodiment will be described with reference to FIG. 14. In the eleventh embodiment, an exterior of the tubular conductor 310 may be covered by an insulator 330. The insulator 330 may be connected to the ground or to the power supply via the high-resistance 410. Even if the insulator 330 is charged when the charged droplet 201 passes inside the tubular conductor 310, an electric charge accumulated in the insulator 330 may be released to the ground via the high-resistance 410. An electronic material having such a property that an electric charge may be released to the ground in a predetermined time may be used for the high-resistance 410. Alternatively, a high-resistance coating may be formed on the insulator 330 covering the tubular conductor 310.

### Twelfth Embodiment

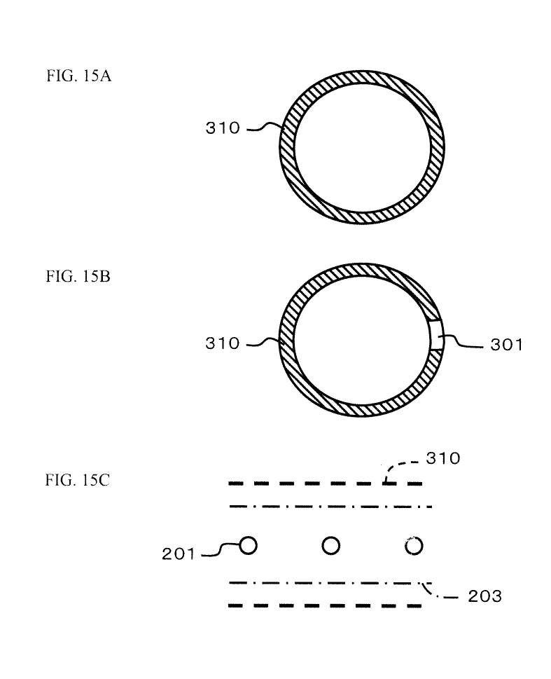

A twelfth embodiment will be described with reference to FIGS. 15A through 15C. A shape of the tubular conductor 310 according to the twelfth embodiment will be described. FIG. 15A is a sectional view of the tubular conductor 310 taken along the plane perpendicular to the axis thereof. The tubular conductor 310 may be, in the cross-sectional view, in the shape of a closed circle or a polygon.

As illustrated in FIG. 15B, a gap 301 may be formed in the tubular conductor 310. For example, the tubular conductor 310 may have a generally C-shaped cross-section.

As illustrated in FIG. 15C, the tubular conductor 310 may, for example, be formed in a coil shape, in a mesh shape, and in a shape in which many rings are connected. In these cases, many gaps may be formed in the tubular conductor 310. The trajectory of the droplet 201 may vary depending on the potential distribution along the traveling path 203. The size of the gap may be set in consideration of such a trajectory variation.

### Thirteenth Embodiment

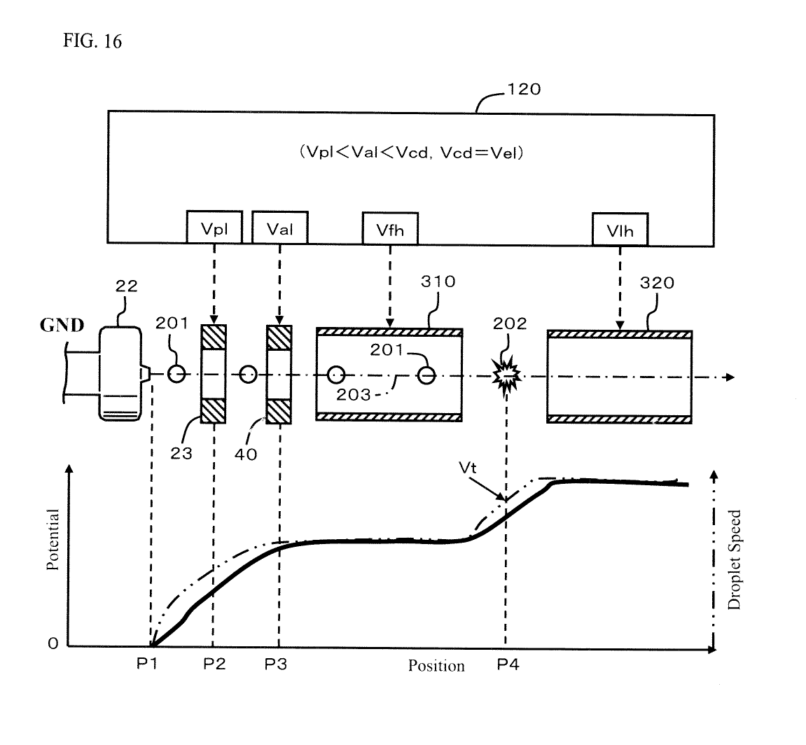

A thirteenth embodiment will be described with reference to FIG. 16. In the thirteenth embodiment, a tubular conductor (upstream-side tubular conductor) 310 may be provided on a path upstream of the plasma generation region, and another tubular conductor (downstream-side tubular conductor) 320 may be provided on a path downstream of the plasma generation region, along the traveling path 203 of the droplet 201.

As illustrated at the bottom of FIG. 16, the potential Vfh of the upstream-side tubular conductor 310 may be set at a substantially equal value to that of the potential Val of the second electrode 40. The potential Vlh of the downstream-side tubular conductor 320 may be set at positive potential that is higher than the potential Vfh (Vlh>Vfh, Vfh≈Val).

The potential Vfh of the upstream-side tubular conductor 310 may be set at a substantially equal value to that of the potential Val of the second electrode 40. Thus, the droplet 201 passing through the upstream-side tubular conductor 310 may be prevented from being decelerated and may be sent to the plasma generation region.

Debris which has passed the plasma generation region or droplets 201 which have not been irradiated with the driver laser beam LB may pass through the downstream-side tubular conductor 320. As a result, the debris and droplets 201 are accelerated. The debris and droplets 201 may not be diffused inside the chamber 10 and may be collected by the collection unit 50.

### Fourteenth Embodiment

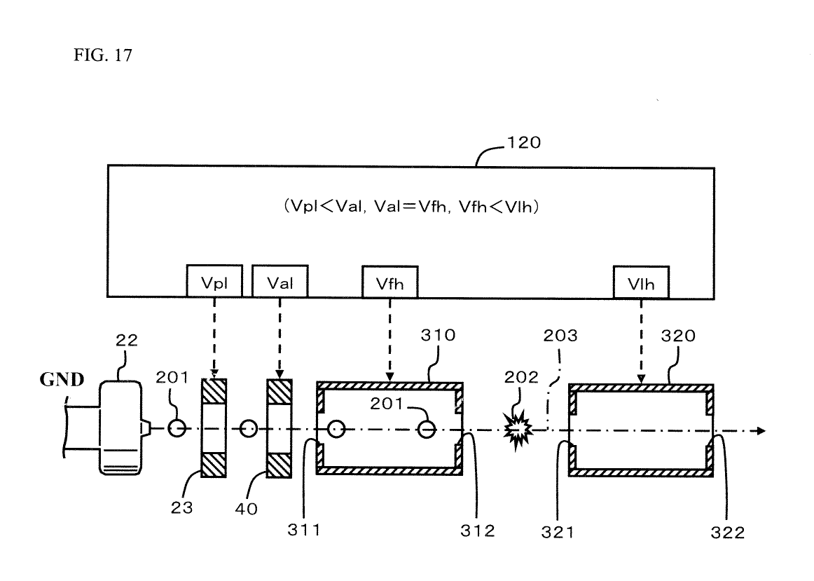

A fourteenth embodiment will be described with reference to FIG. 17. In the fourteenth embodiment, inlets and outlets of the respective tubular conductor 310 and 320 may be made as small as possible. An inlet 311 and an outlet 312 of the upstream-side tubular conductor 310 and an inlet 321 and an outlet 322 of the downstream-side tubular conductor 320 may be set small enough not to disturb the movement of the droplet 201.

Such a configuration may prevent the electric field outside the tubular conductors 310 and 320 from interfering the interior of the tubular conductors 310 and 320 to affect the traveling of the droplet 201.

### Fifteenth Embodiment

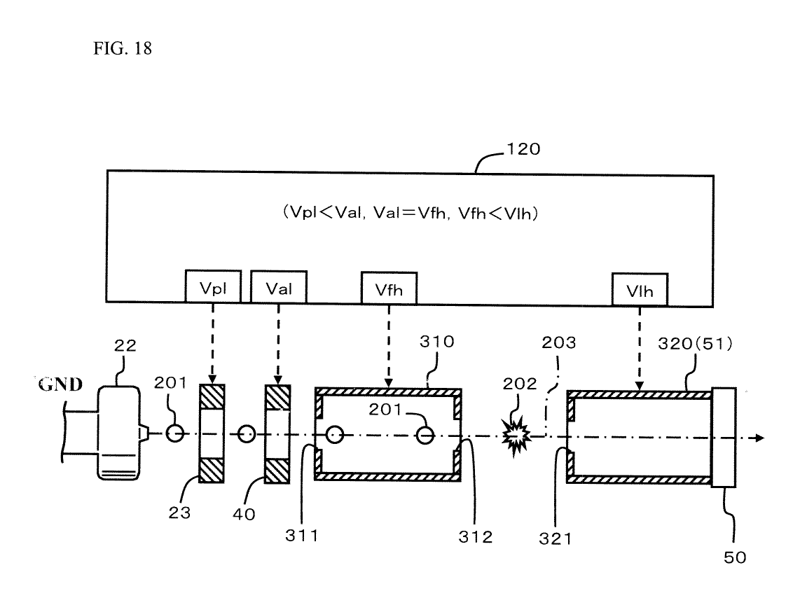

A fifteenth embodiment will be described with reference to FIG. 18. In the fifteenth embodiment, the downstream-side tubular conductor 320 and the collection unit 50 maybe integrated. The collection body 51 of the collection unit 50 may be used as the tubular conductor 320. This may reduce the number of constituent elements.

### Sixteenth Embodiment

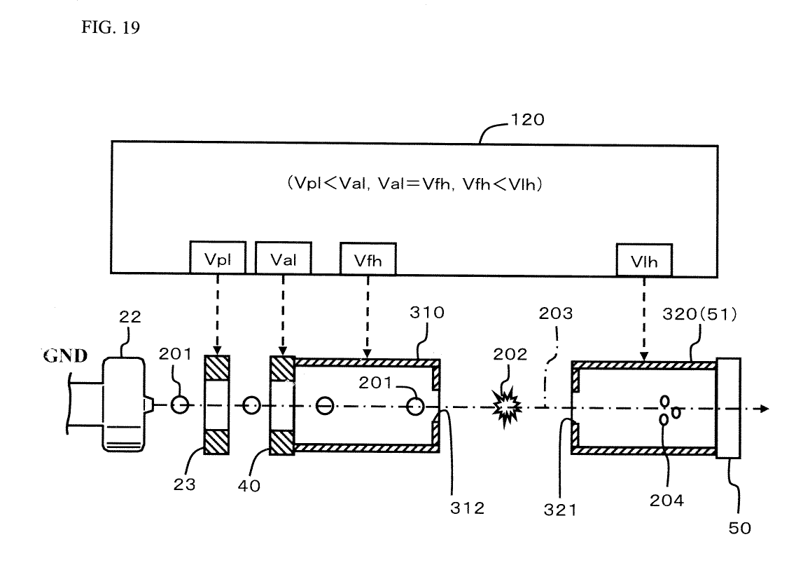

A sixteenth embodiment will be described with reference to FIG. 19. In the sixteenth embodiment, the upstream-side tubular conductor 310 and the second electrode 40 may be integrated. The tubular conductor 310 may be integrally provided on a downstream-side surface of the second electrode 40. Further, as mentioned in relation to the fifteenth embodiment, the downstream-side tubular conductor 320 and the collection unit 50 may be integrated. This may further reduce the number of elements.

### Seventeenth Embodiment

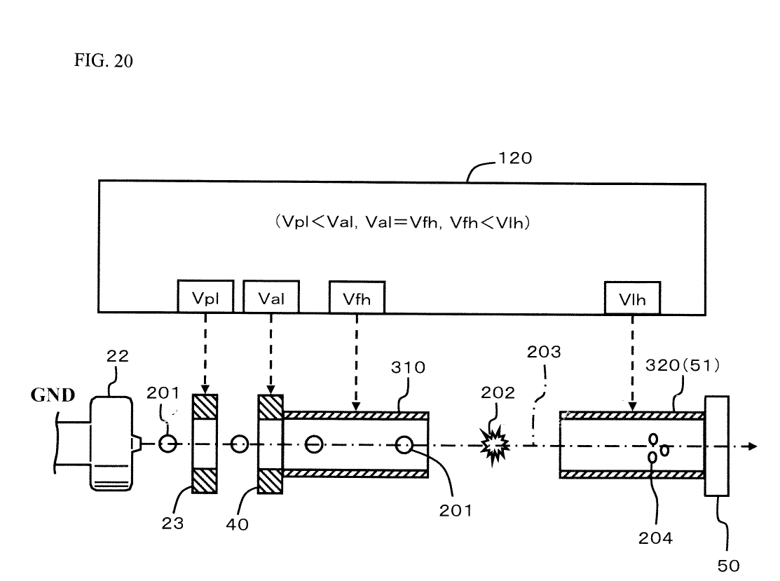

A seventeenth embodiment will be described with reference to FIG. 20. According to the seventeenth embodiment, in the configuration of the sixteenth embodiment, inner diameters of the tubular conductors 310 and 320 may be made as small as possible. Here, making the inner diameters as small as possible means that they may be made small enough not to interfere the traveling of the droplet 201.

### Eighteenth Embodiment

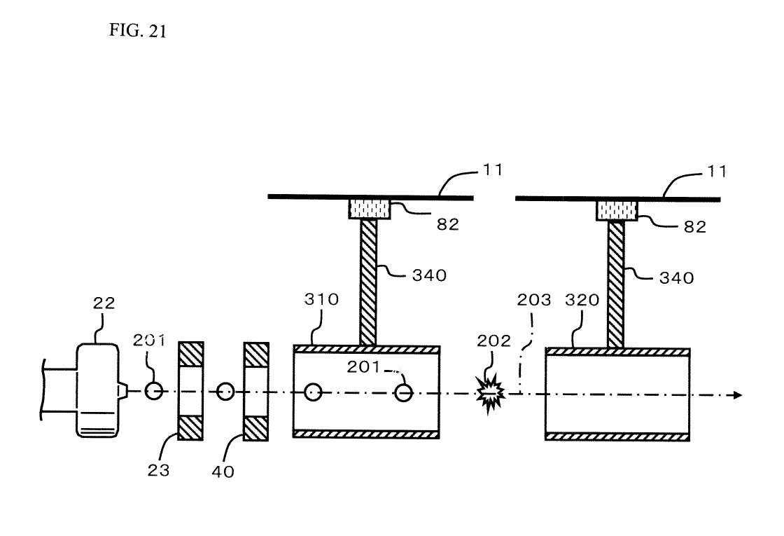

An eighteenth embodiment will be described with reference to FIG. 21. In the eighteenth embodiment, a method of mounting the tubular conductors 310 and 320 may be illustrated. The tubular conductors 310 and 320 may, for example, be mounted to a wall 11 of the chamber 10 via a stay 340 and an insulator 82. Instead of the wall 11 of the chamber 10, the stay 340 may be mounted to the droplet generator 20.

### Nineteenth Embodiment

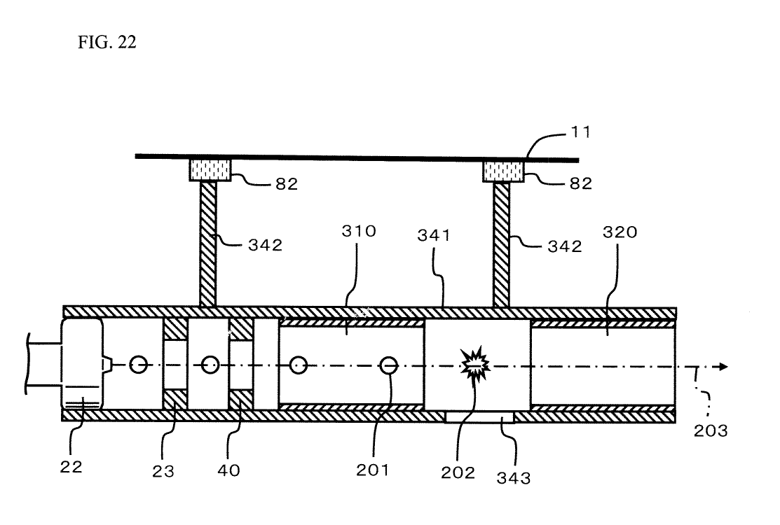

A nineteenth embodiment will be described with reference to FIG. 22. In the nineteenth embodiment, at least part of the nozzle unit 22, the first electrode 23, the second electrode 30, and the tubular conductors 310 and 320 may be disposed inside a support member 341. The support member 341 may be cylindrical, and it may be mounted to the wall 11 of the chamber 10 or to the droplet generator 20 via a stay 342 and an insulator 82.

The driver laser beam LB may be incident on the support member 341 in a direction perpendicular to the face of the sheet of FIG. 22. The support member 341 may have openings, through which the driver laser beam LB may pass.

The nozzle unit 22, the first electrode 23, the second electrode 40, and the tubular conductors 310 and 320 may be included in the single support member 341. Thus, the above elements can be positioned accurately. Further, such a configuration may reduce a mounting time of those elements and the number of necessary elements. Part of the support member 341 at which the support member may make contact with the above elements can preferably be made of an insulator.

### Twentieth Embodiment

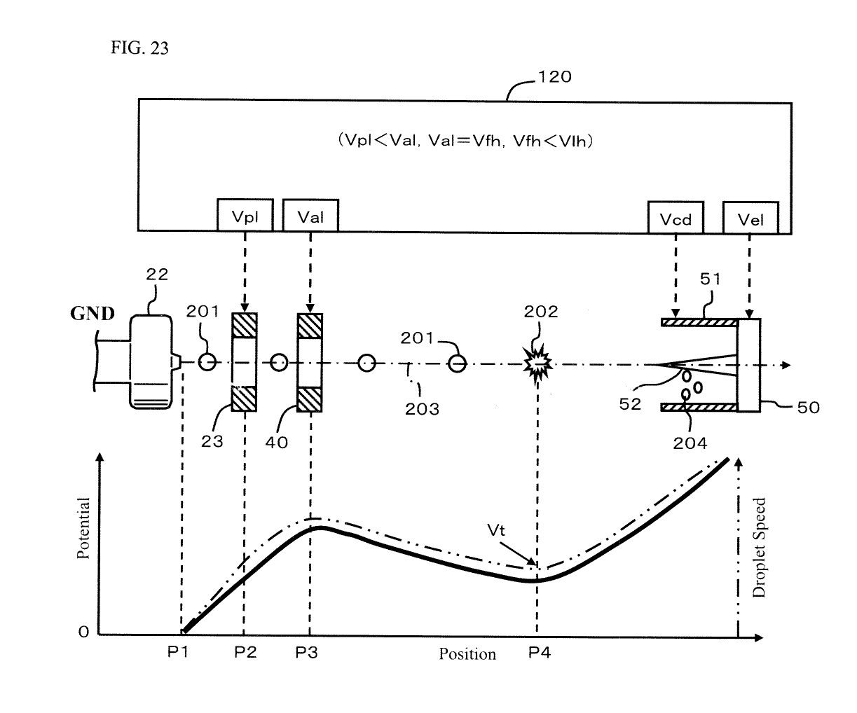

A twentieth embodiment will be described with reference to FIG. 23. In the twentieth embodiment, the potential of the collection unit 50 may be set to the highest in the potential of each element along the traveling path 203. The potential Vel of the third electrode 52 and the potential Vcd of the collection body 51 may be set at substantially the same value (Vpl<Val<Vcd, Vcd=Vel).

Applying the highest positive potential to the collection unit 50 can accelerate debris or droplets 201 that have not been irradiated with the driver laser beam LB and pull them toward the collection unit 50. In FIG. 23, the debris and the droplet that has not been irradiated with the laser beam are indicated by reference numeral 204.

Further, since the third electrode 52 may be provided at the center of the collection body 51, the electric field may be enhanced at the third electrode 52. Accordingly, more debris or droplets 204 may be collected by the collection unit 50.

### Twenty-First Embodiment

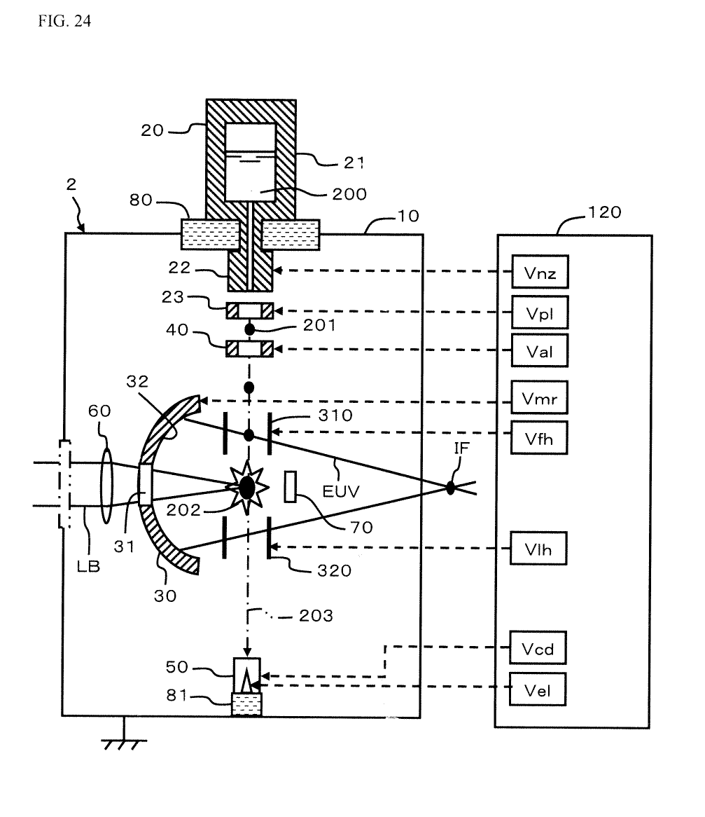

A twenty-first embodiment will be described with reference to FIG. 24. In the twenty-first embodiment, the potentials of the tubular conductors 310 and 320 and the collection unit 50 may be controlled in the case where the droplet generator 20 is mounted to the chamber 10 via an insulator 80.

Technical features of the above-described tubular conductors 310 and 320 and the collection unit 50 may be applied to the configuration in which the nozzle unit 22 is set at a positive potential.

### Twenty-Second Embodiment

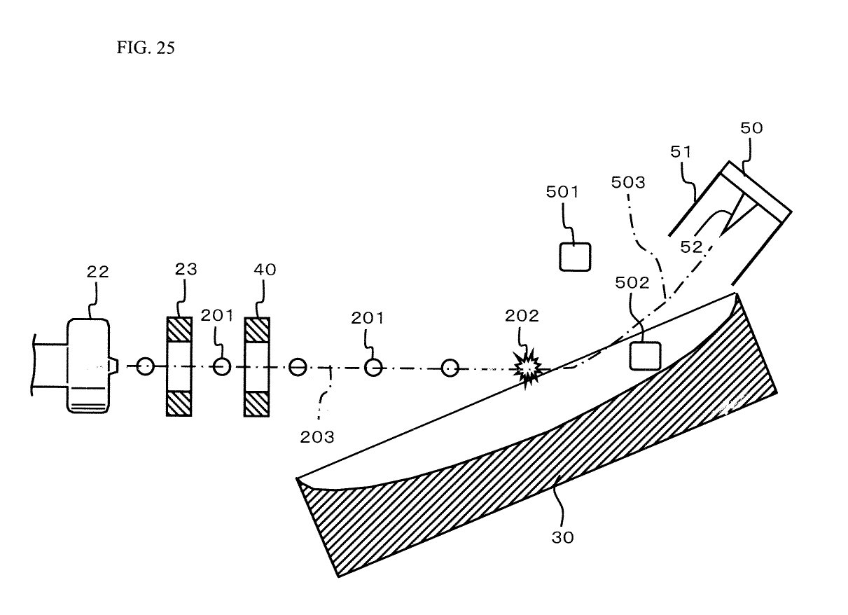

A twenty-second embodiment will be described with reference to FIG. 25. In the twenty-second embodiment, adjustment electrodes 501 and 502 may be used to generate electric lines of force. Thus, the potential distribution may be modified and the movement path 203 of the droplet 201 may be made to a nonlinear movement path 503 in the vicinity of the collector mirror 30.

The droplet 201 may travel along the modified traveling path 503 and be subsequently collected by the collection unit 50. The debris may be prevented from adhering to the collector mirror 30 and other structural elements inside the chamber.

The above descriptions are merely illustrative and not limiting. Accordingly, it is apparent to those skilled in the art that modifications can be made to the embodiments of this disclosure without departing from the scope of this disclosure.

The terms used in this specification and the appended claims should be interpreted as “non-limiting.” For example, the terms “include” and “be included” should be interpreted as “not limited to the stated elements.” The term “have” should be interpreted as “not limited to the stated elements.” Further, the modifier “one (a/an)” should be interpreted as “at least one” or “one or more.”

What is claimed is:

1. A chamber apparatus used in combination with a laser apparatus, the chamber apparatus comprising:
a chamber with an inlet, the inlet being configured for introducing a laser beam from the laser apparatus into the chamber;
a target supply unit provided to the chamber, and configured to supply a target material into the chamber, the target supply unit being electrically isolated from the chamber; and
a potential control unit connected to at least the target supply unit, and configured to control the supply of the target material.

2. The chamber apparatus according to claim 1, wherein:
the chamber is grounded;
the target supply unit includes
an outlet configured to output the target material, and
a first electrode adjacent to the outlet, the outlet and the first electrode, spaced apart from each other, being arranged in that order along a traveling path for the target material to travel in the chamber; and
the potential control unit is configured to control potential of the outlet and potential of the first electrode.

3. The chamber apparatus according to claim 2, wherein the potential control unit is configured to perform the potential control so that the potential of the outlet is higher than the potential of the first electrode.

4. The chamber apparatus of claim 2, wherein:
the target supply unit further includes a second electrode adjacent to the first electrode, the outlet, the first electrode, and the second electrode, spaced apart from each other, being arranged in that order along the traveling path; and
the potential control unit is configured to perform the potential control so that potential of the second electrode is not higher than the potential of the first electrode.

5. The chamber apparatus according to claim 3, further comprising a collection unit in the chamber for collecting the target material, wherein
the potential control unit is configured to perform the potential control so that potential of the collection unit is lower than the potential of the first electrode.

6. The chamber apparatus according to claim 3, further comprising a collector mirror in the chamber, wherein
the potential control unit is configured to perform the potential control so that potential of the collector mirror is lower than the potential of the outlet and higher than the potential of the first electrode.

7. The chamber apparatus according to claim 1, further comprising at least one potential maintenance unit disposed in the traveling path of the target material.

8. The chamber apparatus according to claim 7, wherein the potential maintenance unit includes a hollow member.

9. The chamber apparatus according to claim 7, wherein the potential maintenance unit is made of an electrically conductive material.

10. A chamber apparatus used in combination with a laser apparatus, the chamber apparatus comprising:
a chamber with an inlet, the inlet being configured for introducing a laser beam from the laser apparatus into the chamber;
a target supply unit configured to supply a target material in the chamber; and
a potential control unit connected to at least the target supply unit, and configured to control the supply of the target material.

11. The chamber apparatus according to claim 10, wherein:
the chamber and the target supply unit are grounded;
the target supply unit includes
an outlet configured to output the target material, and
a first electrode adjacent to the outlet, the outlet and the first electrode, spaced apart from each other, being arranged in that order along a traveling path for the target material to travel in the chamber; and
the potential control unit is configured to control potential of the outlet and potential of the first electrode.

12. The chamber apparatus according to claim 11, wherein the potential control unit is configured to perform the potential control so that the potential of the outlet is higher than the potential of the first electrode.

13. The chamber apparatus of claim 11, wherein
the target supply unit further includes a second electrode adjacent to the first electrode, the outlet, the first electrode, and the second electrode, spaced apart from each other, being arranged in that order along a traveling path of the target material in the chamber, and
the potential control unit is configured to perform the potential control so that potential of the second electrode is not higher than the potential of the first electrode.

14. The chamber apparatus according to claim 12, further comprising a collection unit in the chamber for collecting the target material, wherein
the potential control unit is configured to perform the potential control so that potential of the collection unit is higher than the potential of the second electrode.

15. The chamber apparatus according to claim 10, further comprising at least one potential maintenance unit disposed in the traveling path of the target material.

16. The chamber apparatus according to claim 15, wherein the potential maintenance unit includes a hollow member.

17. The chamber apparatus according to claim 15, wherein the potential maintenance unit is made of an electrically conductive material.
